(19) United States
(12) Patent Application Publication
(10) Pub. No.: US 2026/0133042 A1
(43) Pub. Date: May 14, 2026

(54) VIRTUAL CONTENT INDICATORS FOR LOCATION SENSING

(71) Applicant: QUALCOMM Incorporated, San Diego, CA (US)

(72) Inventors: Varun Amar REDDY, San Diego, CA (US); Gamini Dinesh GARG, San Diego, CA (US)

(21) Appl. No.: 18/946,165

(22) Filed: Nov. 13, 2024

(51) Int. Cl. G01C 21/36; G06F 3/01; G06T 7/70; G06T 19/00

(52) U.S. Cl. CPC G01C 21/365; G06F 3/017; G06T 7/70; G06T 19/00

(57) ABSTRACT

Systems and techniques are described herein for an extended reality device. For example, a computing device can determine a location of a second device relative to a first device. The computing device can generate virtual content for display at the first device to direct a user of the first device to the location of the second device. The virtual content can be based on a distance and direction from the first device to the second device. The computing device can determine an updated location of the second device and modify the virtual content to include at least one of an updated distance or an updated direction from the first device to the second device to direct the user of the first device to the updated location.

### TECHNICAL FIELD

The present disclosure generally relates to extended reality (XR) systems. For example, aspects of the disclosure relate to systems and techniques for generating virtual content indicators for location sensing in XR systems.

### BACKGROUND

Extended reality (XR) technologies can be used to present virtual content to users, and/or can combine real environments from the physical world and virtual environments to provide users with XR experiences. The term XR can encompass virtual reality (VR), augmented reality (AR), mixed reality (MR), and the like. XR systems can allow users to experience XR environments by overlaying virtual content onto a user's view of a real-world environment.

For example, an XR head-mounted device (HMD) may include a display that allows a user to view the user's real-world environment through a display of the HMD (e.g., a transparent display). The XR HMD can display virtual content at the display in the user's field of view overlaying the user's view of their real-world environment. Such an implementation can be referred to as “see-through” XR. As another example, an XR HMD may include a scene-facing camera that can capture images of the user's real-world environment.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In some aspects, an apparatus for providing extended reality at a first device is provided. The apparatus can include at least one memory; and at least one processor coupled to the at least one memory. The at least one processor can be configured to: determine a location of a second device relative to the first device; generate virtual content for display at the first device, the virtual content based on a distance and direction from the first device to the second device to direct a user of the first device to the location of the second device; determine an updated location of the second device; and modify the virtual content to include at least one of an updated distance or an updated direction from the first device to the second device to direct the user of the first device to the updated location.

In some aspects, a method for providing extended reality at a first device is provided. The method can include: determining a location of a second device relative to the first device; generating virtual content for display at the first device, the virtual content based on a distance and direction from the first device to the second device to direct a user of the first device to the location of the second device; determining an updated location of the second device; and modifying the virtual content to include at least one of an updated distance or an updated direction from the first device to the second device to direct the user of the first device to the updated location.

In some aspects, a non-transitory computer-readable medium is provided having stored thereon instructions that, when executed by at least one processor, cause the at least one processor to: determine a location of a second device relative to the first device; generate virtual content for display at the first device, the virtual content based on a distance and direction from the first device to the second device to direct a user of the first device to the location of the second device; determine an updated location of the second device; and modify the virtual content to include at least one of an updated distance or an updated direction from the first device to the second device to direct the user of the first device to the updated location.

In some aspects, an apparatus for providing extended reality at a first device is provided. The apparatus can include: means for determining a location of a second device relative to the first device; means for generating virtual content for display at the first device, the virtual content based on a distance and direction from the first device to the second device to direct a user of the first device to the location of the second device; means for determining an updated location of the second device; and means for modifying the virtual content to include at least one of an updated distance or an updated direction from the first device to the second device to direct the user of the first device to the updated location.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

FIG. 1 is a block diagram illustrating an architecture of an example extended reality (XR) system, according to aspects of the disclosure;

FIG. 2 is a block diagram illustrating an example of a wireless communication network that can be employed by the disclosed systems and techniques for generating virtual content indicators for location sensing, according to aspects of the disclosure;

FIG. 3 is a diagram illustrating a design of a base station and a User Equipment (UE) device that enable transmission and processing of signals exchanged between the UE and the base station, which may be employed by the disclosed systems and techniques for generating virtual content indicators for location sensing, according to aspects of the disclosure;

FIG. 4 is a diagram illustrating an example extended reality (XR) system, according to aspects of the disclosure;

FIG. 5 is a diagram illustrating another example extended reality (XR) system, according to aspects of the disclosure;

FIG. 6A-6B is a diagram illustrating an example scenario of using an extended reality (XR) device in communication with a vehicle, according to aspects of the disclosure;

FIG. 7A-7B is a diagram illustrating an example scenario of using an extended reality (XR) device detecting gestures, according to aspects of the disclosure;

FIG. 8 is a flow diagram illustrating an example process for generating and modifying virtual content for location sensing, according to aspects of the disclosure;

FIG. 9 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs) (which may also be referred to as a head-mounted devices), XR glasses (e.g., AR glasses, MR glasses, etc.) (also referred to as smart or network-connected glasses), among others. In some cases, XR glasses are an example of an HMD. In some cases, an XR system can track parts of the user (e.g., a hand and/or fingertips of a user) to allow the user to interact with items of virtual content.

XR systems can include virtual reality (VR) systems facilitating interactions with VR environments, augmented reality (AR) systems facilitating interactions with AR environments, mixed reality (MR) systems facilitating interactions with MR environments, and/or other XR systems.

For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. For example, AR content can include adding a heads-up display (HUD) providing informational virtual content to users regarding their environment. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment (e.g., an AR environment, VR environment, and/or MR environment) can be interacted with in a seemingly real or physical way. For example, as a user experiencing an AR environment (e.g., an augmented version of a real-world environment) moves in the real world, rendered virtual content (e.g., images rendered in a virtual environment during an AR experience) also changes, giving the user the perception that the user is moving within the AR environment. For example, a user can turn left or right, look up or down, and/or move forwards or backwards, thus changing the user's point of view of the AR environment. The AR content presented to the user can change accordingly, so that the user's experience in the AR environment is as seamless as it would be in the real world. Similar experiences can be presented in VR and/or MR environments.

In some cases, an XR system can match the relative pose and movement of objects and devices in the physical world. For example, the XR system can use tracking information to calculate the relative pose of devices, persons, objects, and/or features of the real-world environment in order to match the relative position and movement of the devices, objects, and/or the real-world environment. In some examples, the XR system can use the pose and movement of one or more devices, objects, and/or the real-world environment to render content relative to the real-world environment in a convincing manner. The relative pose information can be used to match virtual content with the user's perceived motion and the spatio-temporal state of the devices, objects, and real-world environment. In some cases, an XR system can track parts of the user (e.g., a hand and/or fingertips of a user) to allow the user to interact with items of virtual content.

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

In some examples, an XR device can include an optical “see-through” or “pass-through” display (e.g., see-through or pass-through AR HMD or AR glasses), allowing the XR device to display virtual content (e.g., AR content) directly onto a real-world view without displaying video content. For example, a user can view physical objects through a display (e.g., glasses or lenses), and the XR device can display AR content onto the display to provide the user with an enhanced visual perception of one or more real-world objects. In one example, a display of an optical see-through XR device can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

In further examples, an XR device can be connected wirelessly with other XR devices through various radio frequency, Bluetooth, WiFi, or other wireless technologies. The XR devices can transmit information associated with the environment in which each XR device is located. For example, the XR devices can share direction, location, position, and other information associated with where the XR device or other objects are located within the environment. The XR devices can share other information, such as messages, instructions, and warnings. The XR devices can display the information in a heads-up display (HUD) with icons and other virtual content to convey information to users.

Systems, apparatuses, electronic devices, methods (also referred to as processes), and computer-readable media (collectively referred to herein as “systems and techniques”) are described herein for generating and modifying virtual content based on a position or velocity of one or more XR devices. In some examples, the systems and techniques can include modifying virtual content based on gestures (e.g., hand gestures, finger gestures, head movements, etc.) of a user.

For example, a first user located at a particular location in an environment can view virtual content on an XR device associated with a location of a second user. A first XR device of the first user can transmit and receive information associated with a second XR device of the second user. For example, the first XR device can transmit information associated with the location of the first XR device to the second XR device. The first XR device can use a Global Navigation Satellite System (e.g., a Global Positioning System (GPS)) to determine an absolute location of the first XR device (e.g., longitudinal and latitudinal coordinates). The first XR device can transmit the location of first XR device to the second XR device. Based on the location of the first XR device, the second XR device can generate or modify virtual content displayed to the second user. For example, the second XR device can generate an icon, such as an arrow, directing the first user to the second XR device. In some examples, the virtual content can include a map of the environment in which the second XR device is located with an icon indicating the location on the map where the first XR device is located.

In some aspects, the first user uses an XR device, and the second user does not use an XR device. For example, the second user can use a smartphone or other electronic device which can communicate with the XR device. In further examples, the XR device and other electronic device can communicate through an intermediary device, such as a router or a server. In further aspects, the first user can use a first XR device and the second user can use a second XR device.

In some aspects, the first XR device and the second XR device can transmit or communicate relative locations of the respective XR devices. For example, a first user located in a particular location in an environment (e.g., a room, a building, a park, etc.) can view virtual content on an XR device of the first user (e.g., the first XR device). A second user can use an XR device of the second user (e.g., the second XR device). The second user can arrive at the location in the environment. The second XR device can transmit a radio frequency (RF) signal (e.g., an Institute of Electrical and Electronics Engineers (IEEE) 802.11 (WiFi) signal, a Bluetooth® signal, an ultra-wideband (UWB) signal, a new radio sidelink (NR-SL) signal, etc.). The first XR device can receive the RF signal and can determine a direction and/or distance (e.g., a range) between the first XR device and the second XR device based on the RF signal. The first XR device can determine a distance of the second XR device relative to the first XR device. For example, the first XR device can determine a direction relative to the first XR device in which the second XR device is located.

In some aspects, the XR device can use RF waveforms to perform RF sensing to estimate the distance, angle, and velocity of a target object, such as a vehicle, an obstruction, a user, a building, or other object. The XR device can include a transmitter, a receiver, and at least one processor. The XR device can perform monostatic sensing when one receiver is employed that is co-located with a transmitter. A first XR device can perform bistatic sensing when a receiver of the first XR device is employed that is located remote from a transmitter of a second XR device. Similarly, a radar system may perform multi-static sensing when multiple receivers of multiple devices are employed that are all located remotely from at least one transmitter of at least one device.

In some aspects, the first XR device can include a directional antenna (or multiple antennae) which can be used to determine an angle of arrival of the RF signal. In further examples, the first XR device can determine a distance between the first XR device and the second XR device based on a signal strength of the RF signal. In some examples, the first XR device can determine the distance between the first XR device and the second XR device based on a delay between the sending and receiving the RF signal. In further examples, the second XR device can include a directional antenna or multiple antennae. The first XR device can determine an orientation of the second XR device (e.g., relative to the first XR device) based on a signal strength of the RF signal received by the directional antenna.

In some cases, the first user uses an XR device, and the second user does not use an XR device. In some examples, the XR device can communicate with other electronic devices, such as a smartphone, tablet, smartwatch, etc. In other examples, the first user uses a first XR device and the second user uses a second XR device.

In some aspects, the first XR device can include a camera or other optical sensor. When the second user is within range and field of view of the camera, the first XR device can modify virtual content displayed to the first user based on gestures of the second user. For example, the second user can point at an object in the environment within field of view of the camera. The first XR device can display virtual content associated with the object, generate an arrow pointing toward the object, or generate an arrow pointed in the direction of the gesture. The second user can perform various other gestures within field of view of the first XR device. The first XR device can perform actions and modify virtual content in response to detecting a gesture by the second user.

In some cases, the first XR device and the second XR device can include a camera or other optical sensor. A first user associated with the first XR device can gesture within field of view of the first XR device camera. The first XR device can transmit information associated with the gesture to the second XR device. The second XR device can generate virtual content associated with the gesture to display to a second user. In some examples, the second XR device can generate virtual content based on the gesture and the location of the first XR device. For example, when the gesture is pointing at an object, the second XR device can infer from the location of the first XR device and the direction of the gesture, a relative direction of the object from the location of the second XR device. For example, directions can be relative to the user based on which direction the user is facing. A first user facing a second user while pointing to the left points to the right of the second user from the perspective of the second user. The second XR device can determine the relative direction of the object based on the location of the first user and the direction of the gesture. The second XR device can generate virtual content (e.g., an arrow) based on the relative direction to direct the second user to the object.

In further aspects, a user can use an XR device in communication with a vehicle. The vehicle, such as a car, can communicate with the XR device using an electronic device associated with the vehicle. For example, the XR device can receive RF signals from the vehicle indicating the location and velocity of the vehicle. When the location of a vehicle is within a predetermined threshold (e.g., within a predetermined distance or range) of the XR device, the XR device can receive RF signals indicating the location of the vehicle. In some examples, the XR device can generate virtual content associated with the location of the vehicle. The XR device can display the virtual content to the user. In some examples, the virtual content is a warning to the user. For example, the XR device can warn the user of the location and velocity of the vehicle. The XR device can generate a recommendation to the user, such as a recommendation that the user move over onto the sidewalk or use caution when crossing a street.

In further aspects, a first user and a second user can begin a virtual session for user profiles associated with one or more XR devices and/or other electronic devices (e.g., a smartphone, smartwatch, etc.). For example, the first user can be a parent and the second user can be a child of the first user. The first user can use an XR device, and the second user can use a smartwatch communicating with the XR device using RF signals. The XR device can generate virtual content based on the RF signals. For example, the smartwatch can communicate a location of the second user. The XR device can generate virtual content directing the first user to the second user, such as an arrow pointing to the user or a map in a HUD indicating the location of the second user. In further examples, the XR device can generate virtual content such as an alert associated with the RF signals from the smartwatch. In one example, the virtual content can be a warning that the second user has exceeded a predetermined range. For example, the first user can set a range associated with how far in distance the smartwatch can be away from the first XR device before triggering a warning. When the smartwatch exceeds the predetermined range, the first XR device can generate and display an alert to the first user.

In some aspects, the virtual session can be a tour with the first user using a first XR device being a tourist and a second user using a second XR device being a tour guide. The first XR device can generate virtual content, such as an arrow, to direct the first user towards the second XR device. The first XR device can include a camera or microphone, which can identify gestures or verbal commands of the second user, and modify virtual content displayed by the first XR device. For example, in response to determining the second user points towards an object in the environment, the first XR device can generate virtual content, such as an arrow, directing the first user to the object or in a direction.

Various aspects of the application will be described with respect to the figures below.

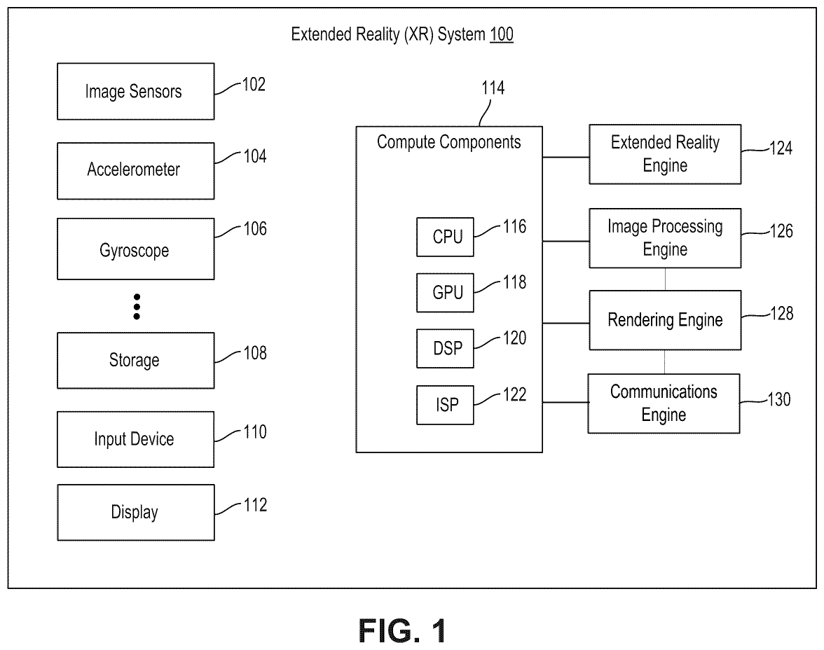

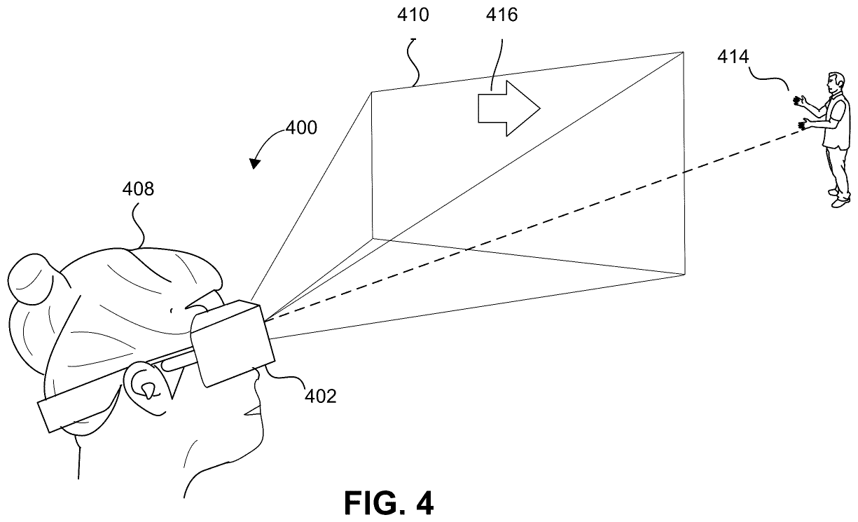

FIG. 1 is a diagram illustrating an architecture of an example extended reality (XR) system 100, in accordance with some aspects of the disclosure. XR system 100 may execute XR applications and implement XR operations. XR system 100 may be an example of, or be included in, any of the XR devices of FIGS. 4, 5, 6A-6B, and 7A-7B.

In this illustrative example, XR system 100 includes one or more image sensors 102, an accelerometer 104, a gyroscope 106, storage 108, an input device 110, a display 112, Compute components 114, an XR engine 126, an image processing engine 128, a rendering engine 130, and a communications engine 132. It should be noted that the components 102-132 shown in FIG. 1 are non-limiting examples provided for illustrative and explanation purposes, and other examples may include more, fewer, or different components than those shown in FIG. 1. For example, in some cases, XR system 100 can include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 1. While various components of XR system 100, such as image sensor 102, may be referenced in the singular form herein, it should be understood that XR system 100 may include multiple of any component discussed herein (e.g., multiple image sensors 102).

Display 112 can be, or can include, a glass, a screen, a lens, a projector, and/or other display mechanism that allows a user to see the real-world environment and also allows virtual content to be overlaid, overlapped, blended with, or otherwise displayed thereon.

XR system 100 can include, or can be in communication with, (wired or wirelessly) an input device 110. Input device 110 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensor 102 can capture images that may be processed for interpreting gesture commands.

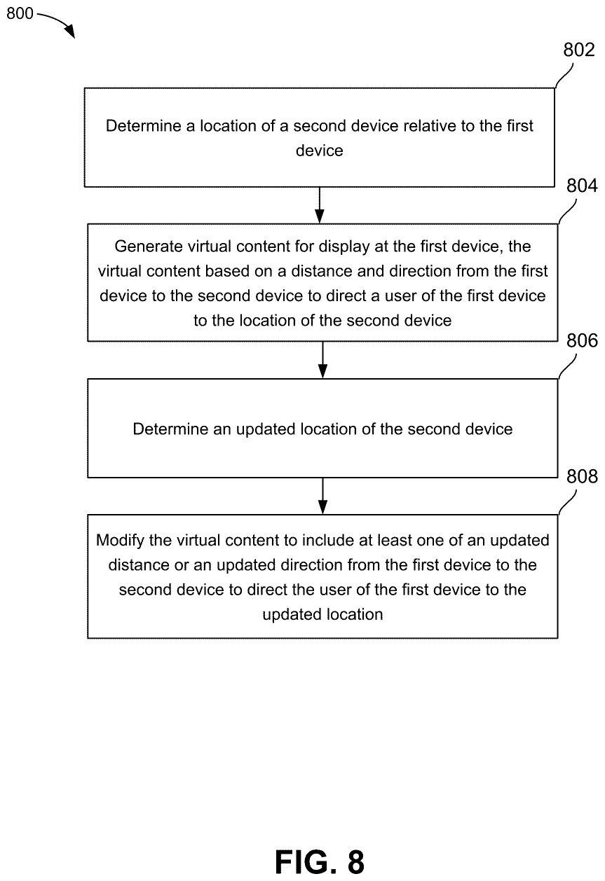

XR system 100 can also communicate with one or more other electronic devices (wired or wirelessly). For example, communications engine 132 can be configured to manage connections and communicate with one or more electronic devices. In some cases, communications engine 132 can correspond to communication interface 826 of FIG. 8.

In some implementations, image sensors 102, accelerometer 104, gyroscope 106, storage 108, display 112, compute components 114, XR engine 126, image processing engine 128, and rendering engine 130 can be part of the same computing device. For example, in some cases, image sensors 102, accelerometer 104, gyroscope 106, storage 108, display 112, compute components 114, XR engine 126, image processing engine 128, and rendering engine 130 may be integrated into an HMD, extended reality glasses, smartphone, laptop, tablet computer, gaming system, and/or any other computing device. However, in some implementations, image sensors 102, accelerometer 104, gyroscope 106, storage 108, display 112, compute components 114, XR engine 126, image processing engine 128, and rendering engine 130 may be part of two or more separate computing devices. For instance, in some cases, some of the components 102-132 may be part of, or implemented by, one computing device and the remaining components can be part of, or implemented by, one or more other computing devices. For example, such as in a split perception XR system, XR system 100 can include a first device (e.g., an HMD), including display 112, image sensor 102, accelerometer 104, gyroscope 106, and/or one or more compute components 114. XR system 100 may also include a second device including additional compute components 114 (e.g., implementing XR engine 126, image processing engine 128, rendering engine 130, and/or communications engine 132). In such an example, the second device may generate virtual content based on information or data (e.g., images, sensor data such as measurements from accelerometer 104 and gyroscope 106) and can provide the virtual content to the first device for display at the first device. The second device can be, or can include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 108 can be any storage device(s) for storing data. Moreover, storage 108 can store data from any of the components of XR system 100. For example, storage 108 may store data from image sensor 102 (e.g., image or video data), data from accelerometer 104 (e.g., measurements), data from gyroscope 106 (e.g., measurements), data from compute components 114 (e.g., processing parameters, preferences, virtual content, rendering content, scene maps, tracking and localization data, object detection data, privacy data, XR application data, face recognition data, occlusion data, etc.), data from XR engine 126, data from image processing engine 128, and/or data from rendering engine 130 (e.g., output frames). In some examples, storage 108 may include a buffer for storing frames for processing by compute components 114.

Compute components 114 can be, or can include a central processing unit (CPU) 116, a graphics processing unit (GPU) 118, a digital signal processor (DSP) 120, an image signal processor (ISP) 122, a neural processing unit (NPU) 124, which may implement one or more trained neural networks, and/or other processors. Compute components 114 may perform various operations such as image enhancement, computer vision, graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 114 may implement (e.g., control, operate, etc.) XR engine 126, image processing engine 128, and rendering engine 130. In other examples, compute components 114 may also implement one or more other processing engines.

Image sensor 102 can include any image and/or video sensors or capturing devices. In some examples, image sensor 102 can be part of a multiple-camera assembly, such as a dual-camera assembly. Image sensor 102 can capture image and/or video content (e.g., raw image and/or video data), which can then be processed by compute components 114, XR engine 126, image processing engine 128, and/or rendering engine 130 as described herein.

In some examples, image sensor 102 can capture image data and can generate images (also referred to as frames) based on the image data and/or may provide the image data or frames to XR engine 126, image processing engine 128, and/or rendering engine 130 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, image sensor 102 (and/or other camera of XR system 100) can be configured to also capture depth information. For example, in some implementations, image sensor 102 (and/or other camera) may include an RGB-depth (RGB-D) camera. In some cases, XR system 100 can include one or more depth sensors (not shown) that are separate from image sensor 102 (and/or other camera) and that may capture depth information. For instance, such a depth sensor may obtain depth information independently from image sensor 102. In some examples, a depth sensor may be physically installed in the same general location or position as image sensor 102 but may operate at a different frequency or frame rate from image sensor 102. In some examples, a depth sensor may take the form of a light source that may project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

XR system 100 can also include other sensors in its one or more sensors. The one or more sensors may include one or more accelerometers (e.g., accelerometer 104), one or more gyroscopes (e.g., gyroscope 106), and/or other sensors. The one or more sensors may provide velocity, orientation, and/or other position-related information to compute components 114. For example, accelerometer 104 may detect acceleration by XR system 100 and may generate acceleration measurements based on the detected acceleration. In some cases, accelerometer 104 may provide one or more translational vectors (e.g., up/down, left/right, forward/back) that may be used for determining a position or pose of XR system 100. Gyroscope 106 can detect and measure the orientation and angular velocity of XR system 100. For example, gyroscope 106 may be used to measure the pitch, roll, and yaw of XR system 100. In some cases, gyroscope 106 may provide one or more rotational vectors (e.g., pitch, yaw, roll). In some examples, image sensor 102 and/or XR engine 126 may use measurements obtained by accelerometer 104 (e.g., one or more translational vectors) and/or gyroscope 106 (e.g., one or more rotational vectors) to calculate the pose of XR system 100. As previously noted, in other examples, XR system 100 may also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of XR system 100, using a combination of one or more accelerometers, one or more gyroscopes, and/or one or more magnetometers. In some examples, the one or more sensors may output measured information associated with the capture of an image captured by image sensor 102 (and/or other camera of XR system 100) and/or depth information obtained using one or more depth sensors of XR system 100.

The output of one or more sensors (e.g., accelerometer 104, gyroscope 106, one or more IMUs, and/or other sensors) can be used by XR engine 126 to determine a pose of XR system 100 (also referred to as the head pose) and/or the pose of image sensor 102 (or other camera of XR system 100). In some cases, the pose of XR system 100 and the pose of image sensor 102 (or other camera) can be the same. The pose of image sensor 102 refers to the position and orientation of image sensor 102 relative to a frame of reference (e.g., field of view of the camera). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees Of Freedom (3DoF), which refers to the three angular components (e.g. roll, pitch, and yaw).

In some cases, a device tracker (not shown) can use the measurements from the one or more sensors and image data from image sensor 102 to track a pose (e.g., a 6DoF pose) of XR system 100. For example, the device tracker can fuse visual data (e.g., using a visual tracking solution) from the image data with inertial data from the measurements to determine a position and motion of XR system 100 relative to the physical world (e.g., the scene) and a map of the physical world. As described below, in some examples, when tracking the pose of XR system 100, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of XR system 100 within the scene and the 3D map of the scene, etc. The 3D map can provide a digital representation of a scene in the real/physical world. In some examples, the 3D map can anchor position-based objects and/or content to real-world coordinates and/or objects. XR system 100 can use a mapped scene (e.g., a scene in the physical world represented by, and/or associated with, a 3D map) to merge the physical and virtual worlds and/or merge virtual content or objects with the physical environment.

In some aspects, the pose of image sensor 102 and/or XR system 100 as a whole can be determined and/or tracked by compute components 114 using a visual tracking solution based on images captured by image sensor 102 (and/or other camera of XR system 100). For instance, in some examples, compute components 114 can perform tracking using computer vision-based tracking, model-based tracking, and/or simultaneous localization and mapping (SLAM) techniques. For instance, compute components 114 can perform SLAM or can be in communication (wired or wireless) with a SLAM system (not shown). SLAM refers to a class of techniques where a map of an environment (e.g., a map of an environment being modeled by XR system 100) is created while simultaneously tracking the pose of a camera (e.g., image sensor 102) and/or XR system 100 relative to that map. The map can be referred to as a SLAM map and can be three-dimensional (3D). The SLAM techniques can be performed using color or grayscale image data captured by image sensor 102 (and/or other camera of XR system 100), and can be used to generate estimates of 6DoF pose measurements of image sensor 102 and/or XR system 100. Such a SLAM technique configured to perform 6DoF tracking can be referred to as 6DoF SLAM. In some cases, the output of the one or more sensors (e.g., accelerometer 104, gyroscope 106, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 102 (and/or other camera) to the SLAM map. For example, 6DoF SLAM can use feature point associations from an input image to determine the pose (position and orientation) of the image sensor 102 and/or XR system 100 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 102 and/or the XR system 100 can be determined by projecting features from the 3D SLAM map into an image or video frame and updating the camera pose from verified 2D-3D correspondences.

In one illustrative example, the compute components 114 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 114 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 100 can also track the hand and/or fingers of the user to allow the user to interact with and/or control virtual content in a virtual environment. For example, the XR system 100 can track a pose, gestures, and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

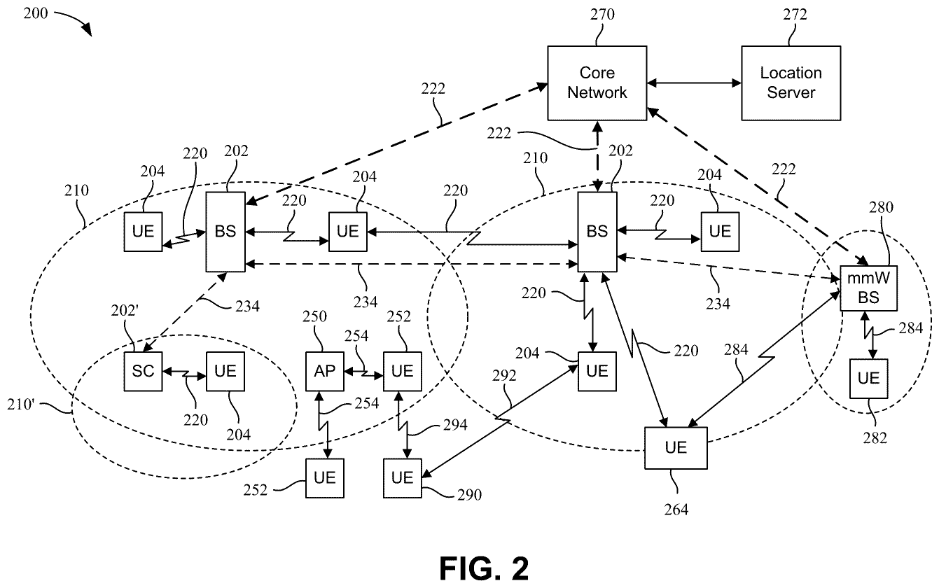

FIG. 2 illustrates an example of a wireless communications system 200 that can be employed by the disclosed systems and techniques generating and modifying virtual content indicators for location sensing, according to various aspects. The wireless communications system 200 (which may also be referred to as a wireless wide area network (WWAN)) can include various base stations 202 and various user equipment devices (UEs) 204. As used herein, the term “UE” may be referred to interchangeably as an “access terminal” or “AT,” a “user device,” a “user terminal” or UT, a “client device,” a “wireless device,” a “subscriber device,” a “subscriber terminal,” a “subscriber station,” a “mobile device,” a “mobile terminal,” a “mobile station,” or variations thereof.

The base stations 202 can include macro cell base stations (high power cellular base stations) and/or small cell base stations (low power cellular base stations). In an aspect, the macro cell base station may include eNBs and/or ng-eNBs where the wireless communications system 200 corresponds to a 4G/LTE network, or gNBs where the wireless communications system 200 corresponds to a 5G/NR network, or a combination of both, and the small cell base stations may include femtocells, picocells, microcells, etc.

The base stations 202 can collectively form a RAN and interface with a core network 270 (e.g., an evolved packet core (EPC) or a 5G core (5GC)) through backhaul links 222, and through the core network 270 to one or more location servers 272 (which may be part of core network 270 or may be external to core network 270). In addition to other functions, the base stations 202 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 202 may communicate with each other directly or indirectly (e.g., through the EPC/5GC) over backhaul links 234, which may be wired and/or wireless.

The base stations 202 can wirelessly communicate with the UEs 204. Each of the base stations 202 may provide communication coverage for a respective geographic coverage area 210. In an aspect, one or more cells may be supported by a base station 202 in each coverage area 210. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 210.

While neighboring macro cell base station 202 geographic coverage areas 210 can partially overlap (e.g., in a handover region), some of the geographic coverage areas 210 may be substantially overlapped by a larger geographic coverage area 210. For example, a small cell base station 202′ can have a coverage area 210′ that substantially overlaps with the coverage area 210 of one or more macro cell base stations 202. A network that includes both small cell and macro cell base stations may be known as a heterogeneous network. A heterogeneous network may also include home eNBs (HeNBs), which may provide service to a restricted group known as a closed subscriber group (CSG).

The communication links 220 (e.g., access links) between the base stations 202 and the UEs 204 can include uplink (also referred to as reverse link) transmissions from a UE 204 to a base station 202 and/or downlink (also referred to as forward link) transmissions from a base station 202 to a UE 204. The communication links 220 can use MIMO antenna technology, including spatial multiplexing, beamforming, and/or transmit diversity. The communication links 220 can be through one or more carrier frequencies. Allocation of carriers may be asymmetric with respect to downlink and uplink (e.g., more or less carriers may be allocated for downlink than for uplink).

The wireless communications system 200 can further include a wireless local area network (WLAN) access point (AP) 250 in communication with WLAN stations (STAs) 252 via communication links 254 in an unlicensed frequency spectrum (e.g., 5 GHz). When communicating in an unlicensed frequency spectrum, the WLAN STAs 252 and/or the WLAN AP 250 may perform a clear channel assessment (CCA) or listen before talk (LBT) procedure prior to communicating in order to determine whether the channel is available. In some examples, the wireless communications system 200 can include devices (e.g., UEs etc.) that communicate with one or more UEs 204, base stations 202, APs 250, etc. utilizing the ultra-wideband (UWB) spectrum. The UWB spectrum can range from 3.1 to 10.5 GHz.

The small cell base station 202′ may operate in a licensed and/or an unlicensed frequency spectrum (e.g., utilizing LTE or NR technology and use the same 5 GHz unlicensed frequency spectrum as used by the WLAN AP 250). The wireless communications system 200 may further include a millimeter wave (mmW) base station 280 that may operate in mmW frequencies and/or near mmW frequencies in communication with a UE 282. In some cases, mmW frequencies can be referred to as the FR2 band (e.g., including a frequency range of 24250 MHz to 52600 MHz). In some examples, the wireless communications system 200 can include one or more base stations (referred to herein as “hybrid base stations”) that operate in both the mmW frequencies (and/or near mmW frequencies) and in sub-6 GHz frequencies (referred to as the FR1 band, e.g., including a frequency range of 450 to 6000 MHz). In some examples, the mmW base station 280, one or more hybrid base stations (not shown), and the UE 282 may utilize beamforming (transmit and/or receive) over a mmW communication link 284 to compensate for the extremely high path loss and short range. The wireless communications system 200 may further include a UE 264 that may communicate with a macro cell base station 202 over a communication link 220 and/or the mmW base station 280 over a mmW communication link 284.

In some examples, in order to operate on multiple carrier frequencies, a base station 202 and/or a UE 204 can be equipped with multiple receivers and/or transmitters. For example, a UE 204 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tuneable to band ‘Z’ only.

The wireless communications system 200 may further include one or more UEs, such as UE 290, that connect indirectly to one or more communication networks via one or more relay devices (e.g., UEs) by using device-to-device (D2D) peer-to-peer (P2P) links (referred to as “sidelinks”). In the example of FIG. 2, UE 290 has a D2D P2P link 292 with one of the UEs 204, which can be configured to operate as a relay device (e.g., through which UE 290 may indirectly communicate with base station 202). In another example, UE 290 also has a D2D P2P link 294 with WLAN STA 252, which is connected to the WLAN AP 250 and can be configured to operate as a relay device (e.g., UE 290 may indirectly communicate with AP 250). In an example, the D2D P2P links 292 and 294 may be supported with any well-known D2D RAT, such as LTE Direct (LTE-D), Wi-Fi Direct (Wi-Fi-D), Bluetooth®, UWB, and so on.

As noted above, UE 204 and UE 290 can be configured to communicate using sidelink communications. In some examples, UE 204 and UE 290 can operate using one or more different modes for sidelink communications. For example, in mode 1 the cellular network (e.g., base station 202) can select and manage the radio resources used by the UEs for performing sidelink communications. In another example, the UE 204 and UE 290 can be configured to operate using mode 2 in which the UEs can autonomously select the radio resources for sidelink communications. Mode 2 can operate without cellular coverage, and in some cases can be considered a baseline sidelink communications mode as devices and/or applications may not depend on the availability of cellular coverage. In some examples, mode 2 can include a distributed scheduling scheme for UEs to select radio resources.

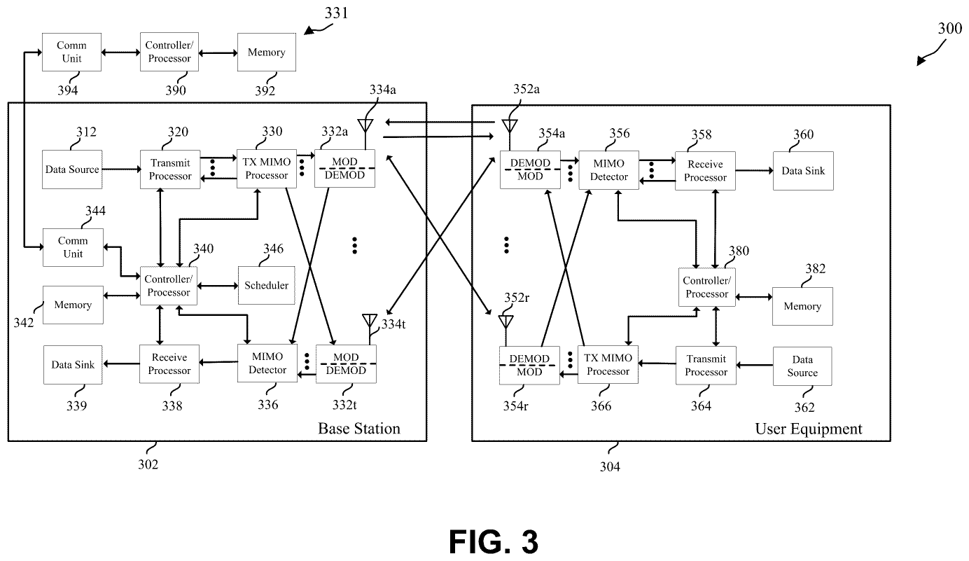

FIG. 3 shows a block diagram of a design 300 of a base station 302 and a UE 304 that enable transmission and processing of signals exchanged between the UE and the base station, which may be employed by the disclosed systems and techniques for generating and modifying virtual content indictors for location sensing, in accordance with some aspects of the present disclosure. Design 300 includes components of a base station 302 and a UE 304, which can be one of the base stations 202 and one of the UEs 204 in FIG. 2. Base station 302 can be equipped with T antennas 334 a through 334t, and UE 304 may be equipped with R antennas 352a through 352r, where in general T≥1 and R≥1.

At base station 302, a transmit processor 320 can receive data from a data source 312 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 320 may also process system information (e.g., for semi-static resource partitioning information (SRPI) and/or the like) and control information (e.g., CQI requests, grants, upper layer signaling, and/or the like) and provide overhead symbols and control symbols. Transmit processor 320 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 330 may perform spatial processing (e.g., precoding) on the data symbols, the control symbols, the overhead symbols, and/or the reference symbols, if applicable, and may provide T output symbol streams to T modulators (MODs) 332a through 332t. The modulators 332a through 332t are shown as a combined modulator-demodulator (MOD-DEMOD). In some cases, the modulators and demodulators can be separate components. Each modulator of the modulators 332a to 332t may process a respective output symbol stream, e.g., for an orthogonal frequency-division multiplexing (OFDM) scheme and/or the like, to obtain an output sample stream. Each modulator of the modulators 332a to 332t may further process (e.g., convert to analog, amplify, filter, and upconvert) the output sample stream to obtain a downlink signal. T downlink signals may be transmitted from modulators 332a to 332t via T antennas 334a through 334t, respectively. According to certain aspects described in more detail below, the synchronization signals can be generated with location encoding to convey additional information.

At UE 304, antennas 352 a through 352r can receive the downlink signals from base station 302 and/or other base stations and may provide received signals to demodulators (DEMODs) 354a through 354r, respectively. The demodulators 354a through 354r are shown as a combined modulator-demodulator (MOD-DEMOD). In some cases, the modulators and demodulators can be separate components. Each demodulator of the demodulators 354a through 354r may condition (e.g., filter, amplify, downconvert, and digitize) a received signal to obtain input samples. Each demodulator of the demodulators 354a through 354r may further process the input samples (e.g., for OFDM and/or the like) to obtain received symbols. A MIMO detector 356 may obtain received symbols from all R demodulators 354a through 354r, perform MIMO detection on the received symbols if applicable, and provide detected symbols. A receive processor 358 may process (e.g., demodulate and decode) the detected symbols, provide decoded data for UE 304 to a data sink 360, and provide decoded control information and system information to a controller/processor 380. A channel processor may determine reference signal received power (RSRP), received signal strength indicator (RSSI), reference signal received quality (RSRQ), channel quality indicator (CQI), and/or the like.

On the uplink, at UE 304, a transmit processor 364 can receive and process data from a data source 362 and control information (e.g., for reports comprising RSRP, RSSI, RSRQ, CQI, and/or the like) from controller/processor 380. Transmit processor 364 may also generate reference symbols for one or more reference signals (e.g., based at least in part on a beta value or a set of beta values associated with the one or more reference signals). The symbols from transmit processor 364 may be precoded by a TX-MIMO processor 366 if application, further processed by modulators 354a through 354r (e.g., for DFT-s-OFDM, CP-OFDM, and/or the like), and transmitted to base station 302. At base station 302, the uplink signals from UE 304 and other UEs may be received by antennas 334a through 334t, processed by demodulators 332a through 332t, detected by a MIMO detector if applicable, and further processed by a receive processor 338 to obtain decoded data and control information sent by UE 304. Receive processor 338 may provide the decoded data to a data sink 339 and the decoded control information to controller (processor) 340. Base station 302 may include communication unit 344 and communicate to a network controller 331 via communication unit 344. Network controller 331 may include communication unit 394, controller/processor 390, and memory 392.

In some aspects, one or more components of UE 304 can be included in a housing. Controller/processor 340 of base station 302, controller/processor 380 of UE 304, and/or any other component(s) of FIG. 3 may perform one or more techniques associated with resource allocation for joint communications and RF sensing.

Memories 342 and 382 may store data and program codes for the base station 302 and the UE 304, respectively. A scheduler 346 may schedule UEs for data transmission on the downlink, uplink, and/or sidelink.

In some implementations, the UE 304 can include a radar receiver that includes: means for determining a sensing measurement accuracy of the radar receiver based on one or more sensing measurements associated with at least one target; and means for transmitting, based on the sensing measurement accuracy, a message to a network entity, the message including an indication to modify an allocation of sensing resources associated with the radar receiver for communications data. In some examples, the means for determining can include controller/processor 380, memories 382, receive processor 358, transmit processor 364, any combination thereof, or any other component(s) of the UE 304. In some examples, the means for transmitting can include controller/processor 380, transmit processor 364, TX-MIMO processor 366, DEMODs 354a through 354r, antennas 352a through 352r, any combination thereof, or any other component(s) of the UE 304.

In some implementations, the base station 302 may include: means for receiving a message from a radar receiver, the message including an indication to modify an allocation of sensing resources associated with the radar receiver for communications data; and means for determining, based on the message, at least a portion of the sensing resources for the communications data. In some examples, the means for receiving can include controller/processor 340, transmit processor 324, TX MIMO processor 336, DEMODs 332a through 332t, antennas 334a through 334t, the scheduler 346, any combination thereof, or any other component(s) of the base station 302. In some examples, the means for determining can include controller/processor 340, memory 342, receive processor 338, transmit processor 320, the scheduler 346, any combination thereof, or any other component(s) of the base station 302.

In some implementations, the base station 302 may include: means for receiving a resource allocation request from a second network entity for an allocation of sensing resources for communications data; and means for transmitting a message to one or more radar devices, the message including information associated with an allocation of at least a portion of resources associated with the one or more radar devices for the communications data. In some examples, the means for receiving can include controller/processor 340, transmit processor 324, TX MIMO processor 336, DEMODs 332a through 332t, antennas 334a through 334t, the scheduler 346, any combination thereof, or any other component(s) of the base station 302. In some examples, the means for transmitting can include controller/processor 340, transmit processor 324, TX MIMO processor 336, DEMODs 332a through 332t, antennas 334a through 334t, the scheduler 346, any combination thereof, or any other component(s) of the base station 302.

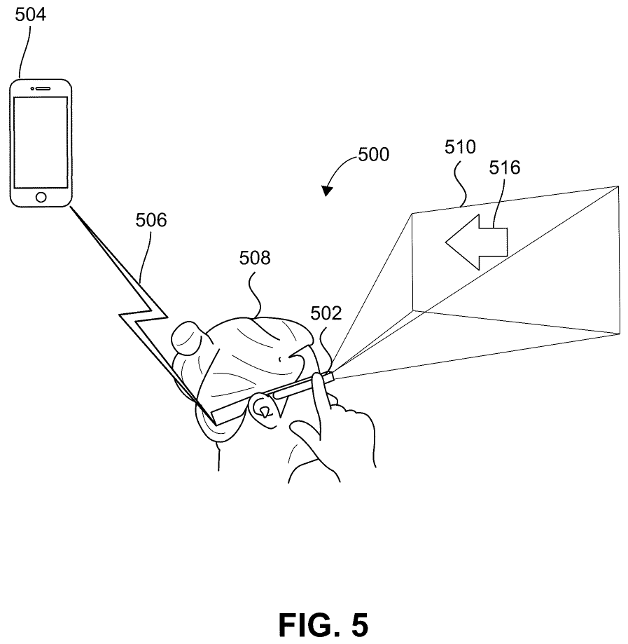

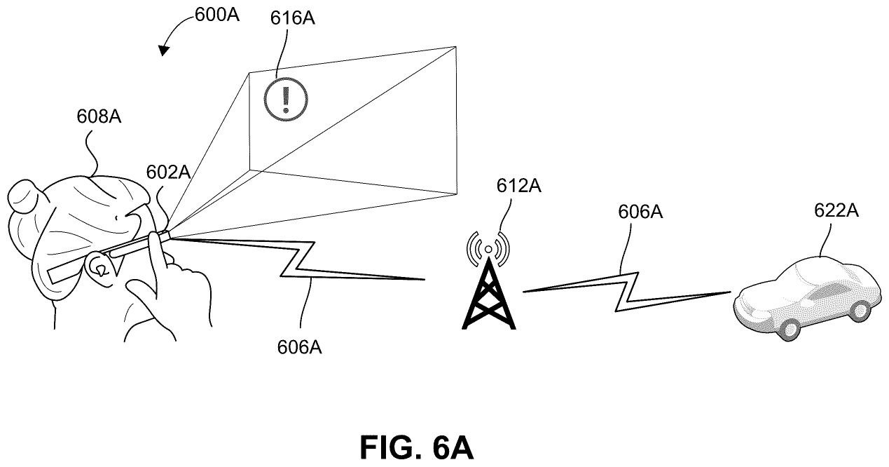

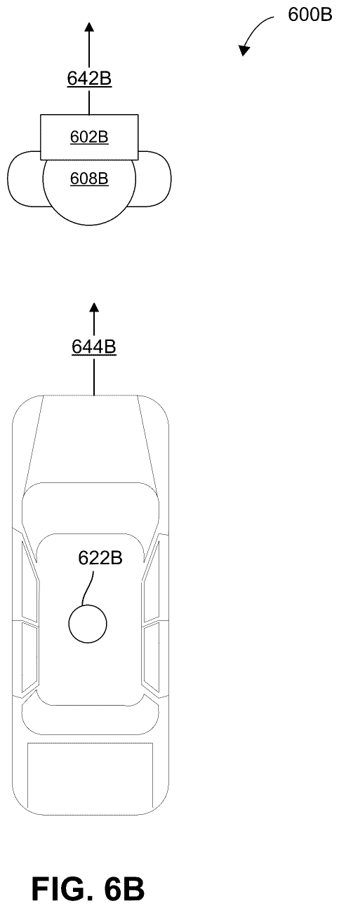

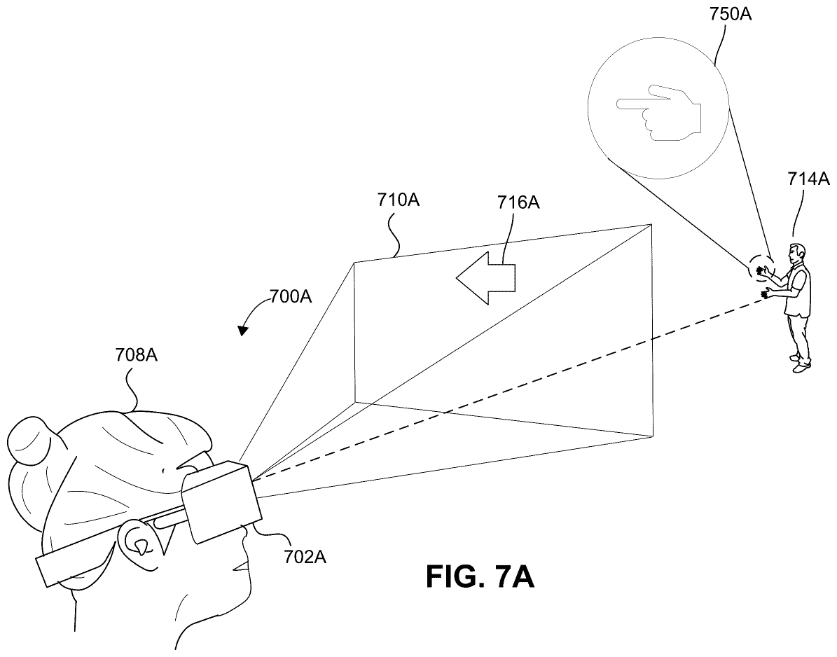

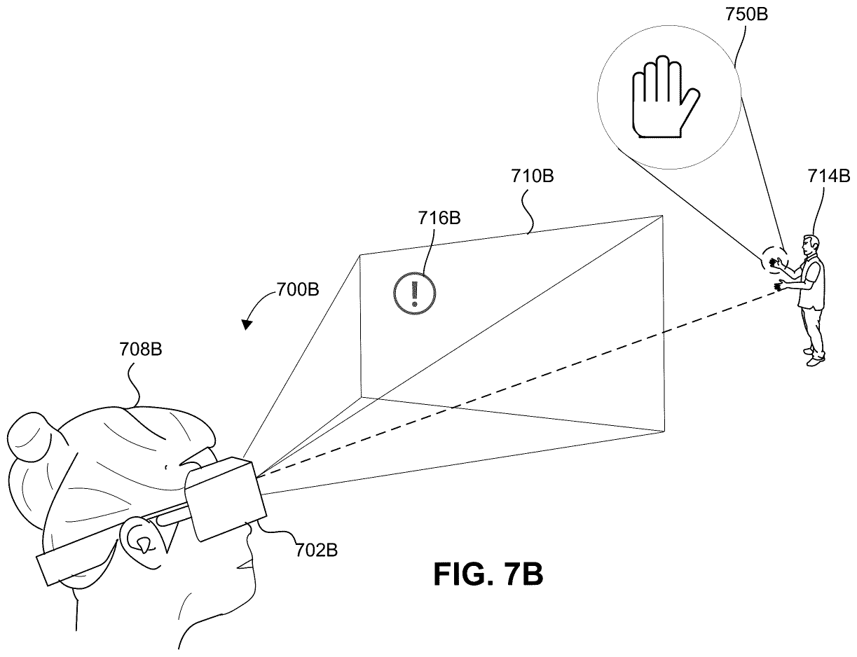

The wireless communication systems of FIG. 2 and FIG. 3 can be implemented in the extended reality (XR) system of FIG. 1, FIG. 4, FIG. 5, FIGS. 6A-6B, and FIGS. 7A-7B. For example, the XR systems can communicate information such as images, location data, velocity data, directional data, etc. to other XR systems or electronic devices using the wireless communication systems.

FIG. 4 is a diagram illustrating an example extended reality (XR) system 400, according to aspects of the disclosure. As shown, XR system 400 includes an XR device 402. XR device 402 may implement, as examples, image-capture, object-detection, object-tracking, gaze-tracking, view-tracking, localization (e.g., determining a location of XR device 402), pose-tracking (e.g., tracking a pose of XR device 402), content-generation, content-rendering, computational, communicational, and/or display aspects of extended reality, including virtual reality (VR), augmented reality (AR), and/or mixed reality (MR). In some examples, the XR device 402 can include the components of the XR system from FIG. 1.

For example, XR device 402 can include one or more cameras that can capture images of a scene 412 in which a user 408 uses XR device 402. XR device 402 can detect a person 414, or object, based on the images of the scene 412. In some examples, the person 414 can use a separate XR device. In other examples, the individual can use another electronic device such as a smartphone, smartwatch, etc. In further examples, the person 414 can be without an XR device or another electronic device. In such an example, the person 414 can be associated with the user 408 or XR device 402. For example, the person 414 can have a user profile which the XR device 402 can use to identify the person 414.

In some aspects, the person 414 and the user 408 of the XR device 402 can begin a virtual session during which the XR device 402 will track the location and direction of the person 414. For example, the XR device 402 can use a camera or optical sensor to identify the person 414 when the person 414 is within a field of view 410 of the camera. The XR device 402 can generate virtual content 416, such as an arrow, pointing to the person 414. The virtual content 416 can include additional information, such as text, an icon, virtual content, or other information indicating the location, direction, and/or velocity of the person 414. Virtual content 416 can highlight the person 414 within the scene 412, causing the person 414 to be emphasized (e.g., to stand out in a crowd or other setting) when viewed by the user 408 through a display of the XR device 402.

In some aspects, the XR device 402 can modify the virtual content 416 as the person 414 or user 408 moves in the environment. For example, when the user 408 moves away from the person 414, the XR device 402 can modify the virtual content 416 to display an updated or changed distance and/or direction.

In some aspects, XR device 402 can include one or more user-facing cameras that can capture images of eyes of a user 408. XR device 402 can determine a gaze of user 408 based on the images of user 408. In some aspects, XR device 402 can determine a person of interest (e.g., person 414) in scene 412 (e.g., based on the gaze of user 408, based on user profile recognition, and/or based on a received indication regarding person 414). XR device 402 can obtain and/or render virtual content 416 (e.g., text, images, and/or video) for display at XR device 402. XR device 402 can display virtual content 416 to user 408 (e.g., within the field of view 410 of user 408). In some aspects, virtual content 416 can be an icon such as an arrow, a map, or text. In some aspects, XR device 402 can display virtual content 416 in relation to the view of user 408 of the person 414. For example, XR device 402 can overlay virtual content 416 onto the field of view 410 of the user 408. For example, the XR device 402 can generate a heads-up display (HUD) for the user 408, which the user 408 can use to navigate the environment to locate person 414.

In a “see-through” configuration, XR device 402 can include a transparent surface (e.g., optical glass) such that virtual content 416 can be displayed on (e.g., by being projected onto) the transparent surface to overlay the view of user 408 of scene 412 as viewed through the transparent surface. In a “pass-through” configuration or a “video see-through” configuration, XR device 402 can include a scene-facing camera that may capture images of scene 412. XR device 402 may display images or video of scene 412, as captured by the scene-facing camera, and virtual content 416 overlaid on the images.

In various examples, XR device 402 can include a head-mounted device (HMD), a virtual reality headset, and/or smart glasses. XR device 402 can include one or more cameras, including scene-facing cameras and/or user-facing cameras, a GPU, one or more sensors (e.g., such as one or more inertial measurement units (IMUs), image sensors, and/or microphones), one or more communication units (e.g., wireless communication units), and/or one or more output devices (e.g., such as speakers, headphones, displays, and/or smart glass).

FIG. 5 is a diagram illustrating an example extended reality (XR) device 500 communicating with an electronic device 504, according to aspects of the disclosure. In some aspects, an XR device can communicate with a plurality of devices, such as multiple XR devices, smartphones, smartwatches, etc. The XR device 502 and electronic device 504 can communicate through a communication link 506 between the XR device 502 and electronic device 504. In some examples, the communication link 506 can be a wireless connection according to any suitable wireless protocol, such as, for example, Institute of Electrical and Electronics Engineers (IEEE) 802.11 (Wi-Fi), IEEE 802.15, or Bluetooth®. In some cases, communication link 506 can be a direct wireless connection between XR device 502 and electronic device 504. In other cases, the communication link 506 can be through one or more intermediary devices, such as, for example, routers or switches and/or across a network.

In further examples, the XR device 502 can include a receiver, such as the receiver from FIGS. 2-3, which can receive radio frequency (RF) signals from the electronic device 504. In further examples, the XR device 502 can communicate with a server or cloud service and receive information associated with the electronic device 504. In further examples, the XR device 502 can use 3G, 4G, 5G, and other cellular technologies to communicate with the electronic device 504.

For example, XR device 502 can capture and/or generate data, such as image data (e.g., from user-facing cameras and/or scene-facing cameras) and/or velocity data (e.g., motion data from an inertial measurement unit (IMU)). The electronic device 504 can provide location, direction, and velocity data to the XR device 502. For example, the electronic device 504 can communicate the location of the electronic device 504 to the XR device using the communication link 506.

The XR device 502 can generate virtual content 516 based on the location, direction, and velocity data associated with the electronic device 504. For example, the virtual content can be an icon, such as an arrow or map, to indicate the direction the which the electronic device 504 is located. In further examples, the virtual content 516 can include textual information associated with the location, direction, and velocity of the electronic device 504. For example, the virtual content can include text such as “Electronic Device is 2 miles away moving at 5 miles per hour northeast of your current position”. The XR device 502 can modify the virtual content 516 as the electronic device 504 changes location, direction, and velocity.

In some examples, a user 508 of the XR device 502 and a user of the electronic device 504 can establish the communication link between the XR device 502 and the electronic device 504 for a preset period of time. For example, the user 508 can establish a virtual session for preset period of time during which the XR device 502 and the electronic device 504 can communicate location, direction, and velocity. During the session, the XR device 502 can generate virtual content associated with the location, direction, and velocity of the electronic device 504.

In some examples, the XR device 502 can generate virtual content 516 associated with the relative locations of the XR device 502 and the electronic device 504. For example, the XR device 502 can determine, based on RF signals of the electronic device 504, a location of the electronic device 504 relative to the location of the XR device 502. The XR device 502 can use various techniques such as time of arrival or angle of arrival calculations to identify a distance and direction of the electronic device. The XR device 502 can generate virtual content 516 such as an arrow pointing in the direction of the electronic device 504 relative to the XR device 502 and text stating the distance from the XR device 502 to the electronic device 504.

In some examples, the XR device 502 can generate virtual content 516 associated with an absolute location of the XR device 502 and the electronic device 504. The XR device 502 and electronic device 504 can use a Global Navigation Satellite System (e.g., a global positioning system (GPS)) to determine an absolute location of the XR device 502 and the electronic device 504. The XR device 502 and electronic device 504 can communicate coordinates of each respective device using the communication link 506. The XR device 502 can generate virtual content 516 based on the coordinates.

In some examples, the XR device 502 and electronic device 504 can communicate with an intermediary device, such as a server operating a web service. The server can communicate additional information to the XR device 502 and the electronic device 504. For example, the electronic device 504 can communicate coordinates representing the location of the electronic device 504. The server can provide an address associated with the coordinates to the XR device 502. The XR device 502 can generate virtual content 516 associated with the address, such as by displaying the address to the user 508.

In some examples, the XR device 502 and the electronic device 504 can periodically transmit location information to each other. The frequency of transmissions can be related to the relative direction, distance, and velocity of the XR device 502 and the electronic device 504. The frequency of transmissions can increase (e.g., more transmissions over a period of time) as the XR device 502 and the electronic device 504 are closer in distance to one another. In further examples, the frequency of transmissions can adjust based on changes in the velocity of one or more of the XR device 502 and the electronic device 504. In one example, the frequency of transmissions can be mapped to a table of distances or velocities. For example, when the distance falls below 5 meters or the velocity of the electronic device 504 exceeds 20 mph, the XR device 502 and electronic device 504 can communicate location information at a higher frequency (e.g., more transmissions over a period of time).

In various examples, XR device 502 can be, or can include, a head-mounted display (HMD), a virtual reality headset, and/or smart glasses. XR device 502 can include one or more cameras, including scene-facing cameras and/or user-facing cameras, a GPU, one or more sensors (e.g., such as one or more inertial measurement units (IMUs), image sensors, and/or microphones), and/or one or more output devices (e.g., such as speakers, headphones, displays, and/or smart glass). Electronic device 504 can be a smartphone, laptop, tablet computer, personal computer, gaming system, any other computing device and/or a combination thereof.

FIG. 6A is a diagram illustrating an example scenario 600A of using an extended reality (XR) device 602A in communication with a vehicle 622A. For example, the scenario 600A includes a user 608A associated with the XR device 602A. The XR device 602A can receive information from a vehicle 622A. In some examples, the XR device 602A and vehicle 622A can communicate through a communication link 606A. The communication link 606A can connect the XR device 602A to the vehicle 622A through a wireless communications system 612A, such as the wireless communications systems of FIG. 2 and FIG. 3.

In some examples, the XR device 602A can communicate with the vehicle 622A when the vehicle 622A is within a predetermined distance of the XR device 602A. When the vehicle 622A is within the predetermined distance, the XR device 602A can generate virtual content 616A based on information received from the vehicle 622A. For example, the XR device 602A can receive the information, such as location and velocity data of the vehicle 622A. When the vehicle 622A is headed towards the XR device 602A, the XR device 602A can generate a warning to the user that the vehicle 622A approaches. The XR device 602A can generate a recommendation to the user 608A based on the location and velocity data. For example, the XR device 602A can recommend the user 608A to stay on the sidewalk or wait on crossing the road.

In further examples, the user 608A can use the XR device 602A when operating a vehicle, such as a bicycle. The XR device 602A can warn the user 608A that the user is being overtaken on the left or right by a vehicle. For example, the XR device 602A can generate virtual content, such as an arrow or a warning sign, to alert the user 608A of a vehicle 622A in the environment. In some examples, the XR device 602A can generate recommendation to the user 608A based on the location and velocity of the user 608A and the vehicle 622A. For example, the XR device 602A can receive additional information from the vehicle 622A and generate recommendations for the XR device 602A based on the information. For example, the XR device 602A can receive information associated with an intent of a driver of the vehicle 622A to turn (e.g., navigation information of the vehicle, turning signals, etc.). The XR device 602A can generate virtual content warning the user 608A of the vehicle 622A turning. In further examples, the XR device 602A can alert the user 608A of a vehicle 622A out of view (e.g., in a blind spot) of the user 608A.

FIG. 6B is a diagram illustrating an aerial view of example scenario 600B of using an extended reality (XR) device 602B in communication with a vehicle 622B. The vehicle 622B is outside of a line-of-sight 642B of the user 608B and the XR device 602B. The XR device 602B can receive RF signals from the vehicle 622B associated with the location and velocity of the vehicle 622B. Based on the received RF signals, the XR device 602B can generate virtual content to be displayed to the user 608B.

In some examples, the vehicle 622B can transmit an alert to the XR device 602B. For example, when the vehicle 622B detects the user 608B in a line-of-sight 644B of the vehicle 622B, the vehicle 622B can transmit virtual content (e.g., a warning) to the XR device 602B. The XR device 602B can display the virtual content to the user 608B.

FIG. 7A-7B are diagrams illustrating example scenarios of using an extended reality (XR) device for detecting gestures to generate or modify virtual content. For example, FIG. 7A includes a scenario 700A with a user 708A of an XR device 702A observing a person 714A within field of view 710A of the user 708A. The person 714A can make a gesture 750A in view of the XR device 702A. For example, the person 714A can perform a pointing gesture with his or her hand. The XR device 702A can generate virtual content 716A based on the gesture 750A. For example, the virtual content 716A can be an arrow in the direction the person 714A points.

For example, the XR device 702A can infer the direction of the gesture 750A based on image data collected by a camera of the XR device 702A. The XR device can generate virtual content based on the direction or type of gesture (e.g., pointing, moving hands up and down, etc.). In some examples, the person 714A can have an additional XR device. The person 714A can be out of the field of view of the user 708A and the XR device 702A. The person 714A can make a gesture in view of an optical sensor (e.g., a camera) of the additional XR device. The additional XR device can communicate the gesture and location of the additional XR device to the XR device 702A. The XR device 702A can infer a direction of the gesture based on the location of the person 714A relative to the XR device 702A. The XR device 702A can generate virtual content 716A associated with the gesture and the direction of the gesture.

FIG. 7B is a diagram of scenario 700B with a user 708B of an XR device 702B. A person 714B is within the field of view of the user 708B or XR device 702B. The XR device 702B can detect a gesture 750B performed by the person 714B. For example, the person 714B can be a crossing guard. The person 714B can put up his or her hand indicating a stopping motion. The XR device 702B can determine, based on the gesture 750B that the person 714B is attempting to tell the user 708B to stop walking. The XR device 702A can generate virtual content 716B to warn the user 708B to stop walking (e.g., generating a virtual content representation of a stop sign).

FIG. 8 is a flow diagram illustrating an example process 800 for modifying virtual content for location sensing, in accordance with aspects of the present disclosure. One or more operations of process 800 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 800. The one or more operations of process 800 may be implemented as software components that are executed and run on one or more processors.

At block 802, the computing device (or component thereof) can determine a location of a second device relative to a first device. In some examples, the computing device can be or include the first device. For example, the computing device can determine the location of the second device relative to a first device based on communications between the first device and the second device. In one such example, the computing device can determine the location of the second device relative to the first device based on a time of arrival or angle of arrival calculations using the received radio-frequency signal. For example, the second device can communicate with the first device by transmitting a radio-frequency signal. The first device can determine a relative location of the second device based on the radio signal based on the amount of time for communications between the device and the angle upon which the radio-frequency signal is received by the first device or second device.

In some examples, the first device or second device can use a global positioning system (e.g., GPS, Global Navigation Satellite System, etc.) to determine the location of the first device or the second device. For example, the second device can transmit coordinates (e.g., longitude and latitude) to the first device to provide the location of the second de vice to the first device.

At block 804, the computing device (or component thereof) can generate virtual content for display at the first device to direct a user of the first device to the location of the second device. In some examples, the computing device is or includes the first device. The virtual content can be based on a distance and direction from the first device to the second device. For example, the computing device can determine the distance and direction from the first device to the second device based on the determination of the location of the second device relative to the first device at block 802.

At block 806, the computing device (or component thereof) determine an updated location of the second device. For example, the second device or first device can be in motion. The updated location of the second device can be an updated location relative to the first device. For example, the second device can be stationary, and the first device can be in motion. The relative location of the second device can change based on a changed location of the first device. In another example, the second device can be in motion and the first device can be stationary. The updated location can be a relative location (e.g., distance and direction of the second device from a reference point such as the first device).

At block 808, the computing device (or component thereof) can modify the virtual content to direct the user of the first device to the updated location. The modified virtual content can include at least one of an updated distance or an updated direction from the first device to the second device. For example, the first device can be further away from the second device. The virtual content can include a value associated with a distance from the first device to the second device. The value can increase as the distance between the first device and the second device increases. In some examples, the virtual content can include an arrow to direct the user in the direction of the second device. The modified virtual content can include changes in the orientation of the arrow based on the updated direction of the second device relative to the first device.

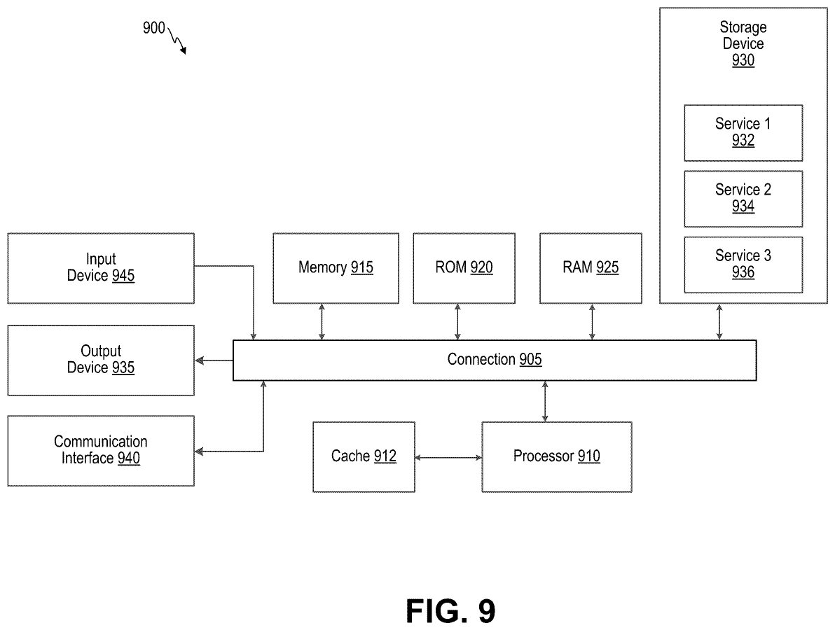

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 900 includes at least one processor, such as a central processing unit (CPU), graphics processing unit (GPU), neural processing unit (NPU), digital signal processor (DSP), image signal processor (ISP), a field programmable gate array (FPGA), an application specific integrated circuit (ASIC), a microprocessor, a controller, another type of processing unit, another suitable electronic circuit, or a combination thereof. The computing system 900 also includes a connection 905 that couples various system components including system memory 915, such as read-only memory (ROM) 920 and random-access memory (RAM) 925 to processor 910. Computing system 900 can include a cache 912 of high-speed memory connected directly with, in close proximity to, or integrated as part of processor 910.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 can essentially be a completely self-contained computing system, containing multiple cores or processors, a bus, memory controller, cache, etc. A multi-core processor can be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface can perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 702.11 Wi-Fi wireless signal transfer, wireless local area network (WLAN) signal transfer, Visible Light Communication (VLC), World wide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 can also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here can easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc. When the code that defines such software is executed by the processor 910, the code causes the system to perform a function. In some aspects, a hardware service that performs a particular function can include the software component stored in a computer-readable medium in connection with the necessary hardware components, such as processor 910, connection 905, output device 935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium can include a non-transitory medium in which data can be stored and that does not include carrier waves and/or transitory electronic signals propagating wirelessly or over wired connections. Examples of a non-transitory medium can include, but are not limited to, a magnetic disk or tape, optical storage media such as compact disk (CD) or digital versatile disk (DVD), flash memory, memory or memory devices. A computer-readable medium can have stored thereon code and/or machine-executable instructions that can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects can be practiced without these specific details. For clarity of explanation, in some instances the present technology can be presented as including individual functional blocks including functional blocks comprising devices, device components, steps or routines in a method embodied in software, or combinations of hardware and software. Additional components can be used other than those shown in the figures and/or described herein. For example, circuits, systems, networks, processes, and other components can be shown as components in block diagram form in order not to obscure the aspects in unnecessary detail. In other instances, well-known circuits, processes, algorithms, structures, and techniques can be shown without unnecessary detail in order to avoid obscuring the aspects.

Individual aspects can be described above as a process or method which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed but could have additional steps not included in a figure. A process can correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions can be, for example, binaries, intermediate format instructions such as assembly language, firmware, source code, etc. Examples of computer-readable media that can be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) can be stored in a computer-readable or machine-readable medium. A processor(s) can perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts can be otherwise variously embodied and employed, and that the appended claims are intended to be construed to include such variations, except as limited by the prior art. Various features and aspects of the above-described application can be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods can be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein can be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present application.

The techniques described herein can also be implemented in electronic hardware, computer software, firmware, or any combination thereof. Such techniques can be implemented in any of a variety of devices such as general purposes computers, wireless communication device handsets, or integrated circuit devices having multiple uses including application in wireless communication device handsets and other devices. Any features described as modules or components can be implemented together in an integrated logic device or separately as discrete but interoperable logic devices. If implemented in software, the techniques can be realized at least in part by a computer-readable data storage medium comprising program code including instructions that, when executed, performs one or more of the methods described above. The computer-readable data storage medium can form part of a computer program product, which can include packaging materials. The computer-readable medium can comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, can be realized at least in part by a computer-readable communication medium that carries or communicates program code in the form of instructions or data structures and that can be accessed, read, and/or executed by a computer, such as propagated signals or waves.

The program code can be executed by a processor, which can include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor can be configured to perform any of the techniques described in this disclosure. A general-purpose processor can be a microprocessor; but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein can refer to any of the foregoing structure, any combination of the foregoing structure, or any other structure or apparatus suitable for implementation of the techniques described herein. In addition, in some aspects, the functionality described herein can be provided within dedicated software modules or hardware modules configured for encoding and decoding or incorporated in a combined video encoder-decoder (CODEC).

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor can only perform at least a subset of operations X, Y, and Z.

Illustrative aspects of the disclosure include:
Aspects 1: An apparatus for providing extended reality at a first device, the apparatus comprising: at least one memory; and at least one processor coupled to the at least one memory and configured to: determine a location of a second device relative to the first device; generate virtual content for display at the first device, the virtual content based on a distance and direction from the first device to the second device to direct a user of the first device to the location of the second device; determine an updated location of the second device; and modify the virtual content to include at least one of an updated distance or an updated direction from the first device to the second device to direct the user of the first device to the updated location.
Aspect 2: The apparatus of Aspect 1, wherein the location of the first device includes an absolute location based on a global positioning system.
Aspect 3: The apparatus of any of Aspects 1 to 2, wherein the location of the first device includes a relative distance and a relative direction from the first device.
Aspect 4: The apparatus of any of Aspects 1 to 3, wherein the virtual content includes an indication of a velocity of the second device.
Aspect 5: The apparatus of any of Aspects 1 to 4, wherein the at least one processor is configured to: receive, from the second device, a radio-frequency signal; and determine the location of the second device based on the received radio-frequency signal.
Aspect 6: The apparatus of Aspect 5, wherein the at least one processor is configured to: determine the location of the second device based at least one of time of arrival or angle of arrival calculations using the received radio-frequency signal.
Aspect 7: The apparatus of any of Aspects 1 to 6, wherein the virtual content is an icon to indicate the location of the first device.
Aspect 8: The apparatus of any of Aspects 1 to 7, wherein the at least one processor is configured to: generate a recommendation directing the user of the first device to move locations based on the updated location of the second device.
Aspect 9: The apparatus of any of Aspects 1 to 8, wherein the at least one processor is configured to: determine the location of the second device based one or more images received from a camera.
Aspect 10: The apparatus of any of Aspects 1 to 9, wherein the at least one processor is configured to: transmit a request to a server for the location of the second device; and determine the location the second device based on a response of the server.
Aspect 11: The apparatus of any of Aspects 1 to 10, wherein the at least one processor is configured to: identify a gesture of a user of the second device; and generate additional virtual content based on the gesture and a relative location of the first device to the second device.
Aspect 12: A method for providing extended reality at a first device, the method comprising: determining a location of a second device relative to the first device; generating virtual content for display at the first device, the virtual content based on a distance and direction from the first device to the second device to direct a user of the first device to the location of the second device; determining an updated location of the second device; and modifying the virtual content to include at least one of an updated distance or an updated direction from the first device to the second device to direct the user of the first device to the updated location.
Aspect 13: The method of Aspect 12, wherein the location of the first device includes an absolute location based on a global positioning system.
Aspect 14: The method of any of Aspects 12 to 13, wherein the location of the first device includes a relative distance and a relative direction from the first device.
Aspect 15: The method of any of Aspects 12 to 14, wherein the virtual content includes an indication of a velocity of the second device.
Aspect 16: The method of any of Aspects 12 to 15, further comprising: receiving, from the second device, a radio-frequency signal; and determining the location of the second device based on the received radio-frequency signal.
Aspect 17: The method of Aspect 16, further comprising: determining the location of the second device based at least one of time of arrival or angle of arrival calculations using the received radio-frequency signal.
Aspect 18: The method of any of Aspects 12 to 17, wherein the virtual content is an icon to indicate the location of the first device.
Aspect 19: The method of any of Aspects 12 to 18, further comprising: generating a recommendation directing the user of the first device to move locations based on the updated location of the second device.
Aspect 20: The method of any of Aspects 12 to 19, further comprising: determining the location of the second device based one or more images received from a camera.
Aspect 21: The method of any of Aspects 12 to 20, further comprising: transmitting a request to a server for the location of the second device; and determine the location the second device based on a response of the server.
Aspect 22: The method of any of Aspects 12 to 21, further comprising: identifying a gesture of a user of the second device; and generating additional virtual content based on the gesture and a relative location of the first device to the second device.
Aspect 23: An apparatus for providing extended reality at a first device is provided. The apparatus includes one or more means for performing operations according to any of Aspects 1 to 11.
Aspect 24: A non-transitory computer-readable medium is provided having stored thereon instructions that, when executed by at least one processor, cause the at least one processor to perform operations according to any of Aspects 12 to 22.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.”

1. An apparatus for providing extended reality at a first device, the apparatus comprising:
at least one memory; and
at least one processor coupled to the at least one memory and configured to:
determine, using one or more Radio Frequency (RF) signals transmitted between the first device and a second device, a location and a velocity of the second device relative to the first device;
generate, based on the location and the velocity of the second device relative to the first device, virtual content for display at the first device, the virtual content including a distance and direction from the first device to the second device to direct a user of the first device to the location of the second device;
determine, using one or more additional RF signals transmitted between the first device and the second device, an updated location and an updated velocity of the second device; and
modify, based on the updated location and the updated velocity, the virtual content to include at least one of an updated distance or an updated direction from the first device to the second device to direct the user of the first device to the updated location.

2. The apparatus of claim 1, wherein the location of the second device includes an absolute location based on a global positioning system.

3. The apparatus of claim 1, wherein the location of the second device includes a relative distance and a relative direction from the first device.

4. The apparatus of claim 1, wherein the virtual content includes an indication of the velocity of the second device.

5. The apparatus of claim 1, wherein the at least one processor is configured to:
receive, from the second device, a radio-frequency signal; and
determine the location of the second device based on the received radio-frequency signal.

6. The apparatus of claim 5, wherein the at least one processor is configured to:
determine the location of the second device based at least one of time of arrival or angle of arrival calculations using the received radio-frequency signal.

7. The apparatus of claim 1, wherein the virtual content is an icon to indicate the location of the second device.

8. The apparatus of claim 1, wherein the at least one processor is configured to:
generate a recommendation directing the user of the first device to move locations based on the updated location of the second device.

9. The apparatus of claim 1, wherein the at least one processor is configured to:
determine the location of the second device based one or more images received from a camera.

10. The apparatus of claim 1, wherein the at least one processor is configured to:
transmit a request to a server for the location of the second device; and
determine the location the second device based on a response of the server.

11. The apparatus of claim 1, wherein the at least one processor is configured to:
identify a gesture of a user of the second device; and
generate additional virtual content based on the gesture and a relative location of the first device relative to the second device.

12. A method for providing extended reality at a first device, the method comprising:
determining, using one or more Radio Frequency (RF) signals transmitted between the first device and a second device, a location and a velocity of the second device relative to the first device;
generating, based on the location and the velocity of the second device relative to the first device, virtual content for display at the first device, the virtual content including a distance and direction from the first device to the second device to direct a user of the first device to the location of the second device;
determining, using one or more additional RF signals transmitted between the first device and the second device, an updated location of the second device; and
modifying, based on the updated location and the updated velocity, the virtual content to include at least one of an updated distance or an updated direction from the first device to the second device to direct the user of the first device to the updated location.

13. The method of claim 12, wherein the location of the second device includes an absolute location based on a global positioning system.

14. The method of claim 12, wherein the location of the second device includes a relative distance and a relative direction from the first device.

15. The method of claim 12, wherein the virtual content includes an indication of the velocity of the second device.

16. The method of claim 12, further comprising:
receiving, from the second device, a radio-frequency signal; and
determining the location of the second device based on the received radio-frequency signal.

17. The method of claim 16, further comprising:
determining the location of the second device based at least one of time of arrival or angle of arrival calculations using the received radio-frequency signal.

18. The method of claim 12, wherein the virtual content is an icon to indicate the location of the second device.

19. The method of claim 12, further comprising:
generating a recommendation directing the user of the first device to move locations based on the updated location of the second device.

20. A non-transitory computer-readable medium is provided having stored thereon instructions that, when executed by at least one processor, cause the at least one processor to:
determine, using one or more Radio Frequency (RF) signals transmitted between a first device and a second device, a location and a velocity of the second device relative to a first device;
generate, based on the location and the velocity of the second device relative to the first device, virtual content for display at the first device, the virtual content including a distance and direction from the first device to the second device to direct a user of the first device to the location of the second device;
determine, using one or more additional RF signals transmitted between the first device and the second device, an updated location of the second device; and
modify, based on the updated location and the updated velocity, the virtual content to include at least one of an updated distance or an updated direction from the first device to the second device to direct the user of the first device to the updated location.
